(19) United States
(12) Patent Application Publication
(10) Pub. No.: US 2010/0056073 A1
(43) Pub. Date: Mar. 4, 2010

(54) IN-CABLE FM TUNER-TRANSMITTER CONNECTOR

(75) Inventors: David Leung, San Mateo, CA (US); Yasuhiro Yamamoto, Los Angeles, CA (US)

Correspondence Address: LARIVIERE, GRUBMAN & PAYNE, LLP, 19 UPPER RAGSDALE DRIVE, SUITE 200, MONTEREY, CA, 93940, US

(73) Assignee: Monster Cable Products, Inc., Brisbane, CA (US)

(21) Appl. No.: 12/201,645

(22) Filed: Aug. 29, 2008

(51) Int. Cl. H04B 1/40

(52) U.S. Cl. 455/77

(57) ABSTRACT

A connecting cable with a built-in FM tuner and transmitter for connecting a portable entertainment device with an external entertainment system for wireless playback from the device to the system over preset frequencies, and which the user can operate without needing to look at the apparatus in order to select a different FM frequency for playback operation if the need arises.

### TECHNICAL FIELD

The present invention relates to cables and tuner-transmitters for connecting portable personal electronic devices with external entertainment systems. More particularly, the present invention relates to connecting cable systems for receiving input from portable personal electronic devices and conveying them to an external entertainment system. Even more particularly, the present invention relates to connecting cables and FM tuner-transmitters for receiving electronic signals from portable personal electronic devices, transforming the signals, and conveying them to an external entertainment system.

### BACKGROUND ART

It is common in the present society for individuals to carry a portable personal electronic device (PPED) which provides to the user an entertaining output, either audio or video, from a memory capability within the PPED. The PPED has evolved from a portable radio which receives a signal from an external source and transforms it into an audible signal presented through either a speaker or ear phones. The typical PPED now contains a memory device which the user can load with music, video, data, etc. for playback at a later time, thus freeing it from the limitation of available local broadcast sources.

When a user is traveling in a vehicle, or otherwise near an external entertainment system (EES) which he desires to use as the playback outlet, it is necessary to wirelessly connect the PPED with the EES. This is frequently accompanied by connecting an FM transmitter between the PPED and the EES. Typically the playback occurs over an unused FM frequency to the EES for receiving the signal from the PPED and presenting it to the user. In a wireless playback mode, the PPED output is transmitted via a low powered short range link at a selected FM frequency. Given the extensive use of the FM frequency bands, the user must have a variety of frequencies from which to choose in order to avoid conflict with an active FM station. The PPED is frequently powered by a cable connection to the vehicle electrical system.

When using the PPED, the user may have occasion to change the settings for the output connection. In a moving vehicle for example, an FM frequency that is not used in one location may be in use in a new location in which the vehicle is operating. To avoid interference between the authorized frequency user and the PPED, the PPED user must change some connection setting. If the PPED user is the vehicle operator, it is imperative that attention to safely driving the vehicle take precedence over changing the PPED settings. Thus, what is needed is a PPED-EES connecting apparatus that the operator can conveniently manipulate without detracting from the safe operation of the vehicle.

### DISCLOSURE OF THE INVENTION

Accordingly, the present invention is an apparatus consisting of a connecting cable with a housing for a built-in FM tuner and transmitter that connects a PPED, such as an iPod®, iPhone®, portable DVD player, and the like, with an EES, such as a home entertainment center, a car radio or a DVD player, and which the user can operate without needing to look at the apparatus in order to select a different FM frequency for playback operation if the need arises.

The present invention uniquely combines an electronic cable in two segments with appropriate electronic connectors for connecting the chosen PPED with an EES. Each cable segment is configured with an electrical jack-type connector on one end and an electronic connector on the other end. A first cable segment has a jack connector at one end for connecting with a vehicle power outlet, and is physically and electrically connected with the housing for passing power to the PPED. The second cable segment has an electronic connector at one end connected physically and electronically with the housing FM circuitry suitable for receiving the signals from the PPED and wirelessly transmitting them to an EES. In the present invention the connection with the EES is a low powered FM frequency wireless link. The distal end of the second cable segment has a jack suitable for connecting with a PPED.

The housing contains detent-type contacts for preset FM frequencies selected from typically unused FM frequencies, or other suitable frequencies as appropriate. Each contact selection provides the user with a tactile feedback that the user can interpret as a positive connection, avoiding the need for the user to visually inspect the selector to determine which frequency is selected. The present invention further incorporates a circular dial selector that can be operated in either a clockwise or counterclockwise direction for alternatively selecting one of the contacts. The dial selector moves a wiper between each of the preset frequency positions, then returns to a neutral position when released. The housing may further contain a display portion to visually confirm to the user the selected frequency in use.

### BRIEF DESCRIPTION OF THE DRAWING

For a better understanding of the present invention, reference is made to the below referenced accompanying Drawing. Reference numbers refer to the same or equivalent parts of the present invention throughout the several figures of the Drawing.

FIG. 1 is a pictorial cut-away view of the housing of the present invention.

FIG. 2 is a line cut-away drawing of the housing of the present invention.

### BEST MODES FOR CARRYING OUT THE INVENTION

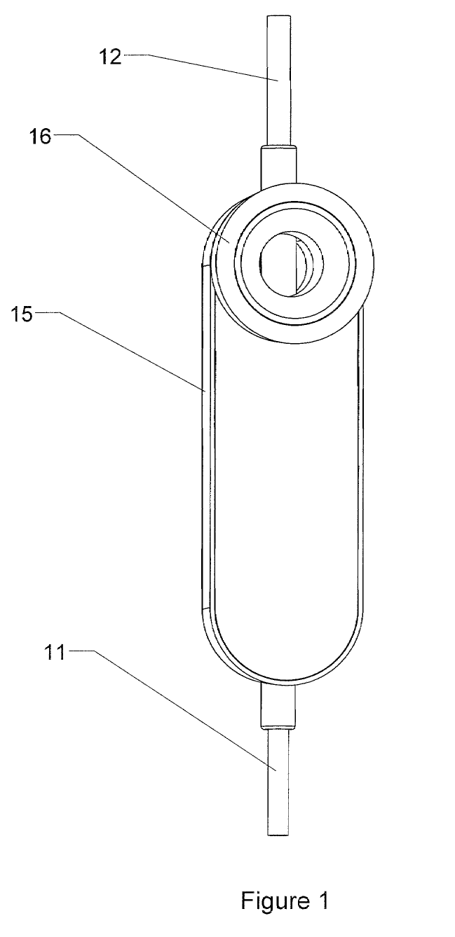

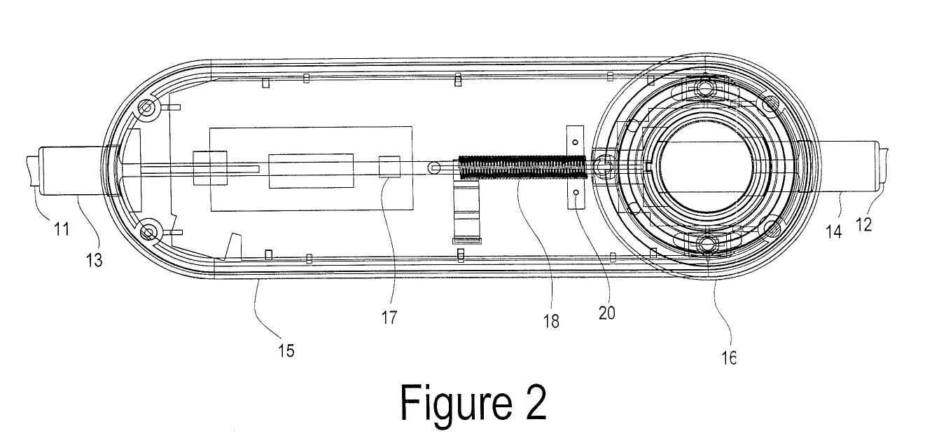

Referring now to FIGS. 1 and 2, cut-away views of an exemplary housing 10 of the preferred embodiment of the present invention are shown. First cable segment 11 goes to a vehicle electrical system outlet and typically is terminated at one end with an electrical jack connector (not shown). Connector 13 is permanently attached to housing 10 and electrically connects cable 11 to the electronic circuitry within housing 10 for providing power to the PPED. Similarly, connector 14 is permanently attached to housing 10 and electrically connects the FM circuitry within housing 10 to second cable 12 for connection with the PPED. Alternatively, connector 14 may be detachable if a variety of cables are desired for connection with a variety of PPEDs. The FM frequency receiver-transmitter (not shown) within housing 10 receives the output signal from the PPED and combines it with an FM carrier for wireless transmission to the EES. In the preferred embodiment, the transmission occurs over a low power wireless link.

The external portion of housing 10 has two sections, a fixed shell 15 and a rotatable frequency selector dial 16. Dial 16 is freely rotatable and selects one of the preset frequencies. Dial 16 is spring loaded as indicated by spring 18 and returns to a neutral position after the user rotates it to select a new frequency. Dial 16 is rotatable in either a clockwise or counterclockwise direction. If desired, the housing may also contain a transparent display section 17. Display section 17 is typically a back-lighted transparent panel which identifies the frequency selected by the user. Alternatively, display section 17 could display any datum or data consisting of lights, symbols or numbers, employing for example, light emitting diodes or printed transparent screens. While a flat housing 10 is shown, it is to be understood that any shape housing could be used without departing from the intent and teaching of this disclosure.

Referring further to FIG. 2, a line cut-away view of the housing 10 of the present invention is shown. Contact 20, representing the three elements shown as small circles, is a detent-type positive connection for a preset operating FM frequency. While there may be as many as five contacts, typically three contacts are sufficient in the preferred embodiment. When dial 16 is rotated by the user, a wiper (not shown) moves from one contact to another. When the wiper reaches a contact, a positive stop occurs due to the detent design of each contact, providing the user with a tactile indication of the quick, positive, and accurate frequency change. The user thus does not need to look at the selector to effect a frequency change. When the user releases dial 16, spring 18 returns dial 16 to a neutral position.

Information as herein shown and described in detail is fully capable of attaining the above-described object of the invention, the presently preferred embodiment of the invention, and is, thus, representative of the subject matter which is broadly contemplated by the present invention. The scope of the present invention fully encompasses other embodiments which may become obvious to those skilled in the art, and is to be limited, accordingly, by nothing other than the appended claims, wherein reference to an element in the singular is not intended to mean “one and only one” unless explicitly so stated, but rather “one or more.”

All structural and functional equivalents to the elements of the above-described preferred embodiment and additional embodiments that are known to those of ordinary skill in the art are hereby expressly incorporated by reference and are intended to be encompassed by the present claims. However, it should be readily apparent to those of ordinary skill in the art that various changes and modifications in form, apparatus material, and fabrication material detail may be made without departing from the spirit and scope of the invention as set forth in the appended claims.

Moreover, no requirement exists for a device or method to address each and every problem sought to be resolved by the present invention, for such to be encompassed by the present claims. Furthermore, no element, component, or method step in the present disclosure is intended to be dedicated to the public regardless of whether the element, component, or method step is explicitly recited in the claims. No claim herein is to be construed under the provisions of 35 U.S.C. 112, sixth paragraph, unless the element is expressly recited using the phrase “means for.”

### INDUSTRIAL APPLICABILITY

The present invention applies industrially to cables for connecting portable personal electronic devices to an external entertainment system for playback of audio, video or data.

What is claimed:

1. An electrical cable for connecting a portable personal electronic device to an external entertainment system, comprising:
a housing containing an FM frequency receiver-transmitter device having a rotatable dial selector for selecting one of at least two pre-set frequency detent contacts for wirelessly transferring an electrical output from the portable personal electronic device to the external entertainment system;
a first cable segment having a jack connector at one end for connection with an external power source and an electrical connector at the distal end for physical and electrical connection with electrical circuitry within the housing; and
a second cable segment having a jack connector at one end for connection with the portable personal electronic device and an electrical connector at the distal end for physical and electrical connection with the FM device within the housing.

2. The electrical cable in accordance with claim 1 further having no more than five detent contacts.

3. The electrical cable in accordance with claim 2 wherein each of the detent contacts is pre-set to a separate FM frequency.

4. The electrical cable in accordance with claim 1 wherein the dial selector is rotatable in either a clockwise or counterclockwise direction.

5. The electrical cable in accordance with claim 4 wherein the dial selector is spring loaded to return to a neutral position after rotation.

6. The electrical cable in accordance with claim 1 with the housing further having a display section.

7. The electrical cable in accordance with claim 6 wherein the display section is a back-lighted transparent panel.

8. The electrical cable in accordance with claim 6 wherein the display section displays one or more datum selected from the group of data consisting of lights, numbers and symbols.

9. An electrical cable for connecting a portable personal electronic device to an external entertainment system, comprising:
a housing containing an FM frequency receiver-transmitter device having a rotatable dial selector for selecting one of a plurality of detent-type contacts for transferring an electrical output from the portable personal electronic device to the external entertainment system, the dial selector being rotatable in either a clock-wise or counterclockwise direction;
a first cable segment having a jack connector at one end for connection with an external source of power and an electrical connector at the distal end for physical connection with the housing and electrical connection for providing power to the FM frequency receiver-transmitter device; and
a second cable segment having a jack connector at one end for connection with the portable personal electronic device and an electrical connector at the distal end for connection with the FM device within the housing;

10. The electrical cable in accordance with claim 9 wherein the rotatable dial selector is spring loaded to return to a neutral position after rotation.

11. The electrical cable in accordance with claim 9 with the housing further having a display section.

12. The electrical cable in accordance with claim 11 wherein the display section is a back-lighted transparent panel.

13. The electrical cable in accordance with claim 12 wherein the display section displays one or more datum selected from the group of data consisting of lights, numbers and symbols.

14. An electrical cable for connecting a portable personal electronic device to an external entertainment system, comprising:
a housing containing an FM frequency receiver-transmitter device having a rotatable dial selector for selecting one of a plurality of detent-type contacts for transferring an electrical output from the portable personal electronic device to the external entertainment system, the dial selector being rotatable in either a clock-wise or counterclockwise direction and spring loaded to return to a neutral position after rotation;
a first cable segment having a jack connector at one end for connection with an external source of power and an electrical connector at the distal end for physical connection with the housing and electrical connection for providing power to the FM frequency receiver-transmitter device; and
a second cable segment having a jack connector at one end for connection with the portable personal electronic device and an electrical connector at the distal end for connection with the FM device within the housing;

15. The electrical cable in accordance with claim 14 with the housing further having a display section.

16. The electrical cable in accordance with claim 15 wherein the display section is a back-lighted transparent panel.

17. The electrical cable in accordance with claim 16 wherein the display section displays one or more datum selected from the group of data consisting of lights, numbers and symbols.
